(19) United States
(12) Patent Application Publication
(10) Pub. No.: US 2020/0053255 A1
(43) Pub. Date: Feb. 13, 2020

(54) TEMPORAL ALIGNMENT OF IMAGE FRAMES FOR A MULTIPLE CAMERA SYSTEM

(71) Applicant: QUALCOMM Incorporated, San Diego, CA (US)

(72) Inventors: Cullum Baldwin, San Diego, CA (US); Karthikeyan Shanmugavadivelu, San Diego, CA (US)

(21) Appl. No.: 16/058,382

(22) Filed: Aug. 8, 2018

(51) Int. Cl. H04N 5/06; H04N 5/247

(52) U.S. Cl. CPC H04N 5/06; H04N 5/247

(57) ABSTRACT

Aspects of the present disclosure relate to systems and methods for temporal alignment of image frames. An example device may include a processor coupled to a memory. The processor may be configured to receive a first stream of image frames from a first camera for an imaging application being executed by the device and receive a second stream of image frames from a second camera for the imaging application being executed by the device. The processor also may be configured to, for a first image frame of the first stream, associate the first image frame with an at least one image frame of the second stream using a type of association. The type of association may be based on the imaging application. The processor further may be configured to provide the associated first image frame and the at least one image frame of the second stream for processing in executing the imaging application.

### TECHNICAL FIELD

This disclosure relates generally to image capture systems and devices, including temporally aligning image frames for a multiple camera system.

### BACKGROUND OF RELATED ART

Many devices and systems use multiple cameras to capture image frames of a scene. Some applications use image frames of a scene with cameras at different perspectives. Three-dimensional (3D) imaging (such as stereoscopic imaging using two cameras) may require each captured frame from one camera to be associated with a captured frame from the other camera. Two or more captured image frames of an object from different perspectives may be used to determine a depth of the object (or various portions of the object), and a 3D image may be generated from processing the captured image frames. Different applications may utilize 3D imaging, including virtual reality (VR), augmented reality (AR), and generating 3D still images or videos for later viewing.

Another application that may use image frames from multiple cameras include applications for stitching images together (such as to increase the field of view offered by one camera by using multiple cameras to capture a scene). For example, a security system may provide a larger field of view of a security feed by stitching image frames from multiple cameras. Another application using image frames from multiple cameras is frozen moment visual effects, where a moment in a video recording may be frozen and viewed from different perspectives of the different cameras. For example, many sporting events now include multiple camera recordings for a studio to offer frozen moment visualizations to a viewer.

An application using image frames from multiple cameras (which may not necessarily have different perspectives) may include image stacking. For example, multiple cameras at different focal lengths may capture image frames of a scene, and different portions of the image frames may be used to generate a final image where objects at different depths in the scene are all in focus (thus increasing the depth of field for image capture).

If the scene changes between an image frame from one camera and the associated image frame from another camera (such as local movement in the scene or global movement of the cameras between the captures from different cameras), artifacts (such as ghosting) may occur in a generated image, the depth incorrectly may be determined for an object in the image, or associated image frames from different cameras may appear to be out of sync.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to systems and methods for temporal alignment of image frames from multiple cameras. In some example implementations, a device may include a processor coupled to a memory. The processor may be configured to receive a first stream of image frames from a first camera for an imaging application being executed by the device and receive a second stream of image frames from a second camera for the imaging application being executed by the device. The processor also may be configured to, for a first image frame of the first stream, associate the first image frame with an at least one image frame of the second stream using a type of association. The type of association may be based on the imaging application. The processor further may be configured to provide the associated first image frame and the at least one image frame of the second stream for processing in executing the imaging application.

An example method includes receiving a first stream of image frames from a first camera for an imaging application being executed by the device and receiving a second stream of image frames from a second camera for the imaging application being executed by the device. The method also includes, for a first image frame of the first stream, associating the first image frame with an at least one image frame of the second stream using a type of association. The type of association may be based on the imaging application. The method further includes providing the associated first image frame and the at least one image frame of the second stream for processing in executing the imaging application.

In a further example, a non-transitory computer-readable medium is disclosed. The non-transitory computer-readable medium may store instructions that, when executed by a processor, cause a device to perform operations including receiving a first stream of image frames from a first camera for an imaging application being executed by the device, receiving a second stream of image frames from a second camera for the imaging application being executed by the device, associating (for a first image frame of the first stream) the first image frame with an at least one image frame of the second stream using a type of association (with the type of association based on the imaging application), and providing the associated first image frame and the at least one image frame of the second stream for processing in executing the imaging application.

In another example, a device is disclosed. The device includes means for receiving a first stream of image frames from a first camera for an imaging application being executed by the device. The device further includes means for receiving a second stream of image frames from a second camera for the imaging application being executed by the device. The device also includes means for, for a first image frame of the first stream, associating the first image frame with an at least one image frame of the second stream using a type of association. The type of association may be based on the imaging application. The device further includes means for providing the associated first image frame and the at least one image frame of the second stream for processing in executing the imaging application.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is a block diagram of an example device for performing imaging using multiple cameras, including temporally aligning image frames.

FIG. 2 is a depiction of an example image frame timeline for a first camera and a second camera.

FIG. 3 is an illustrative flow chart depicting an example operation for temporal alignment of image frames from multiple cameras.

FIG. 4 is a depiction of an example image frame timeline for a first camera and a second camera for which camera configuration based image frame association is performed.

FIG. 5 is a depiction of another example image frame timeline for a first camera and a second camera for which camera configuration based image frame association is performed.

FIG. 6 is a depiction of an example image frame timeline 600 for a first camera and a second camera for which time of receipt based image frame association is performed.

FIG. 7 is a depiction of an example image frame timeline 700 for a first camera and a second camera where the frame rate for the first camera is less than the frame rate for the second camera.

### DETAILED DESCRIPTION

Aspects of the present disclosure may be used for temporal alignment of image frames from multiple cameras. For 3D imaging or other applications using multiple cameras, if image frames between different cameras are not temporally aligned, artifacts or inconsistencies between the image frames may exist. In one example, if a flash or other light source turns on after a first camera image frame capture but before an associated second camera image frame capture, the first camera's image frame may include less captured light and have a lower luminance than the second camera's image frame. In another example, if a bird is flying through the scene, the bird may be at a first location in the scene for the first camera's image frame capture but at a second location in the scene for the second camera's image frame capture. In a further example, if a device including the first camera and the second camera moves between capture of the associated image frames, the scene may change between the image frame captures. To reduce such artifacts and errors, the capture of associated image frames may be temporally aligned.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device capable of capturing images or video (such as security systems, smartphones, tablets, laptop computers, digital video and/or still cameras, web cameras, VR headsets, AR headsets, and so on with two or more cameras or camera sensors). While described below with respect to a device having or coupled to two cameras, aspects of the present disclosure are applicable to devices having any number of cameras (including no cameras, where a separate device is used for capturing images or video which are provided to the device, or three or more cameras for capturing multiple associated image frames), and are therefore not limited to devices having two cameras. Aspects of the present disclosure are applicable for capturing still images as well as for capturing video, and may be implemented in devices having or coupled to cameras of different capabilities (such as a video camera or a still image camera).

The term “device” is not limited to one or a specific number of physical objects (such as one smartphone, one camera controller, one processing system and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects.

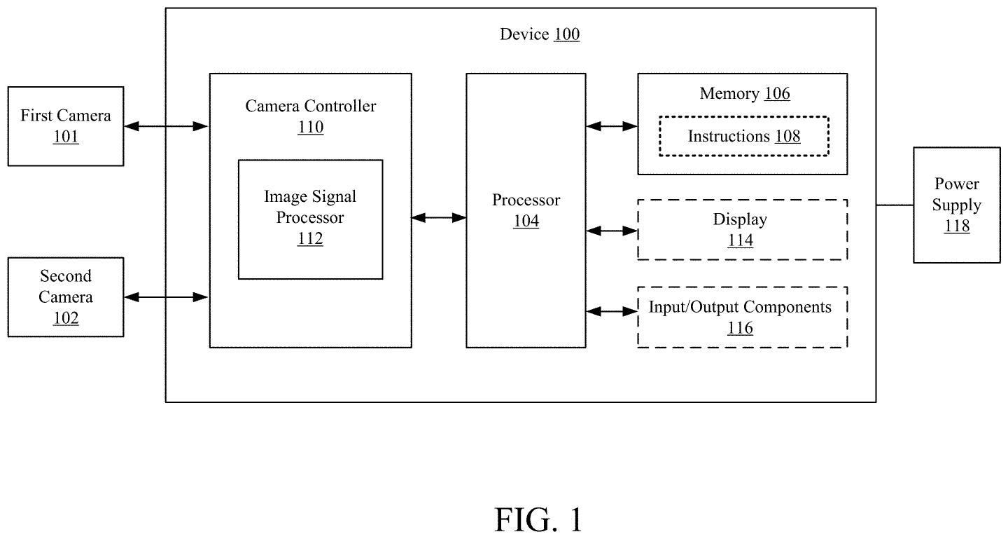

FIG. 1 is a block diagram of an example device 100 for performing 3D imaging. The example device 100 may include or be coupled to a first camera 101, a second camera 102, a processor 104, a memory 106 storing instructions 108, and a camera controller 110. The device 100 may optionally include (or be coupled to) a display 114 and a number of input/output (I/O) components 116. The device 100 may include additional features or components not shown. For example, a wireless interface, which may include a number of transceivers and a baseband processor, may be included for a wireless communication device. The device 100 may include or be coupled to additional cameras other than the first camera 101 and the second camera 102. The disclosure should not be limited to any specific examples or illustrations, including the example device 100.

The first camera 101 and the second camera 102 may be capable of capturing individual image frames (such as still images) and/or capturing video (such as a succession of captured image frames) of a scene from different perspectives. In one example, the first camera 101 and the second camera 102 may be part of a dual camera module. Additionally or alternatively, the cameras 101 and 102 may be separated by a baseline distance used in determining depths of objects in the scene being captured. In another example, the first camera 101 and the second camera 102 may be part of a multiple camera system for stitching, stacking, or comparing image frames of a scene (such as frozen moment visual effects or for increasing a field of view or depth of field). The first camera 101 may be a primary camera, and the second camera 102 may be an auxiliary camera. Each camera may include a single camera sensor, or themselves be a dual camera module or any other suitable module with multiple camera sensors, with one or more sensors being used for capturing images.

The memory 106 may be a non-transient or non-transitory computer readable medium storing computer-executable instructions 108 to perform all or a portion of one or more operations described in this disclosure (such as for temporally aligning capture of image frames between multiple cameras). The device 100 may also include a power supply 118, which may be coupled to or integrated into the device 100.

The processor 104 may be one or more suitable processors capable of executing scripts or instructions of one or more software programs (such as instructions 108) stored within the memory 106. For example, the processor 104 may execute an imaging application requiring image frames from the first camera 101 and the second camera 102 (such as 3D imaging, stitching, or stacking). In some aspects, the processor 104 may be one or more general purpose processors that execute instructions 108 to cause the device 100 to perform any number of functions or operations. In additional or alternative aspects, the processor 104 may include integrated circuits or other hardware to perform functions or operations without the use of software.

While shown to be coupled to each other via the processor 104 in the example of FIG. 1, the processor 104, the memory 106, the camera controller 110, the optional display 114, and the optional I/O components 116 may be coupled to one another in various arrangements. For example, the processor 104, the memory 106, the camera controller 110, the optional display 114, and/or the optional I/O components 116 may be coupled to each other via one or more local buses (not shown for simplicity).

The display 114 may be any suitable display or screen allowing for user interaction and/or to present items (such as captured images, video, or preview images from the multiple cameras) for viewing by a user. In some aspects, the display 114 may be a touch-sensitive display. In one example, the display 114 may be one or more displays for VR, AR, or 3D imaging applications.

The I/O components 116 may be or include any suitable mechanism, interface, or device to receive input (such as commands) from the user and to provide output to the user. For example, the I/O components 116 may include (but are not limited to) a graphical user interface, keyboard, mouse, microphone and speakers, and so on.

The camera controller 110 may include an image signal processor 112, which may be one or more image signal processors to process captured image frames or video provided by the first camera 101 and the second camera 102. For example, the camera controller 110 (such as the image signal processor 112) may temporally align image frames, including associating image frames from the first camera 101 and the second camera 102, and/or process or generate processed image frames from associated image frames from the first camera 101 and the second camera 102. In some example implementations, the camera controller 110 (such as the image signal processor 112) may also control operation of the first camera 101 and the second camera 102. For example, the camera controller 110 (such as the image signal processor 112) may adjust or instruct the cameras to adjust one or more camera settings or configurations (such as the focal length, ISO setting, flash, resolution, capture or frame rate, etc.).

In some aspects, the image signal processor 112 may execute instructions from a memory (such as instructions 108 from the memory 106 or instructions stored in a separate memory coupled to the image signal processor 112) to process image frames or video captured by the first camera 101 and the second camera 102. In other aspects, the image signal processor 112 may include specific hardware to process image frames or video captured by the first camera 101 and the second camera 102. The image signal processor 112 may alternatively or additionally include a combination of specific hardware and the ability to execute software instructions.

For a 3D imaging application or other image applications using multiple cameras, the application may be executed by the processor 104 or another application processor. The image processing pipeline for image frames from the cameras 101 and 102 may be from the cameras to the camera controller 110 (such as the image signal processor 112). In some example implementations, the image signal processor 112 may provide the associated processed image frames to the processor 104 executing the imaging application. The image signal processor 112 may provide associated processed image frames from multiple image streams at different times (such as sequentially) or concurrently.

Some manufacturers may attempt to temporally align image frame captures from different cameras by having the same start of capture or end of capture for each camera. For the start of capture, the camera may begin sampling (which may be described also as measuring, reading, or sensing) the exposed pixels of the camera's image sensor for capturing the scene. In sampling the image sensor, N number of image sensor pixels may be sampled during a clock cycle for the camera. The sampling rate for an image sensor may be based on the clock rate and the type of image sensor. For example, a color image sensor (which may be more complicated based on a color filter array pattern or pixel distribution) may have a slower sampling rate than a monochrome image sensor. Additionally, different image sensors may have differing number of pixels. For example, a 4K image sensor may have more pixels than a Full HD (1080p) image sensor, which may have more pixels than a 720p image sensor. Further, different image sensors may have different exposure rates or times (where one image sensor may require more time than another image sensor to measure light intensities). As a result, the end of capture for a frame (end of frame) from a first camera may be different than the end of frame from a second camera, even if the start of capture of an image frame (start of frame) is the same for both cameras. Further, the exposure of the image sensors may be at different times, which may cause the cameras to capture different temporal instances of the scene.

Other than the image sensors having different characteristics or a clock rate between cameras being different, some cameras may perform interpolation of pixel data or other processing for image frames (such as for anti-aliasing or to artificially increase an image resolution). Further, cameras may have differing latencies such that a start of frame is implemented faster at one camera than another camera to begin sampling pixels of the respective image sensor. Further, the couplings of the cameras may differ to also introduce differing latencies, or the image streams for the different cameras may be processed by different portions of the image processing pipeline (such as different image signal processors). As a result, associated image frames captured by different cameras (such as the first camera 101 and the second camera 102 in FIG. 1) and processed in the image processing pipeline (such as including the image signal processor 112 in FIG. 1) may be received at different times by an applications processor (such as the processor 104 in FIG. 1).

Further, some imaging applications may include requested changes to the configurations of the cameras. For example, while a first camera and a second camera are active, an imaging application may request a flash to be enabled, the focal length or zoom to be adjusted, the ISO to be adjusted, etc. The application processor may instruct a camera controller for a first camera and a second camera to adjust the settings, but the latencies for the cameras may differ. As a result, the adjustment to a first camera may be completed before or after the adjustment to a second camera, and the image frames captured temporally near the camera adjustments may include different configurations as a result of the camera adjustments.

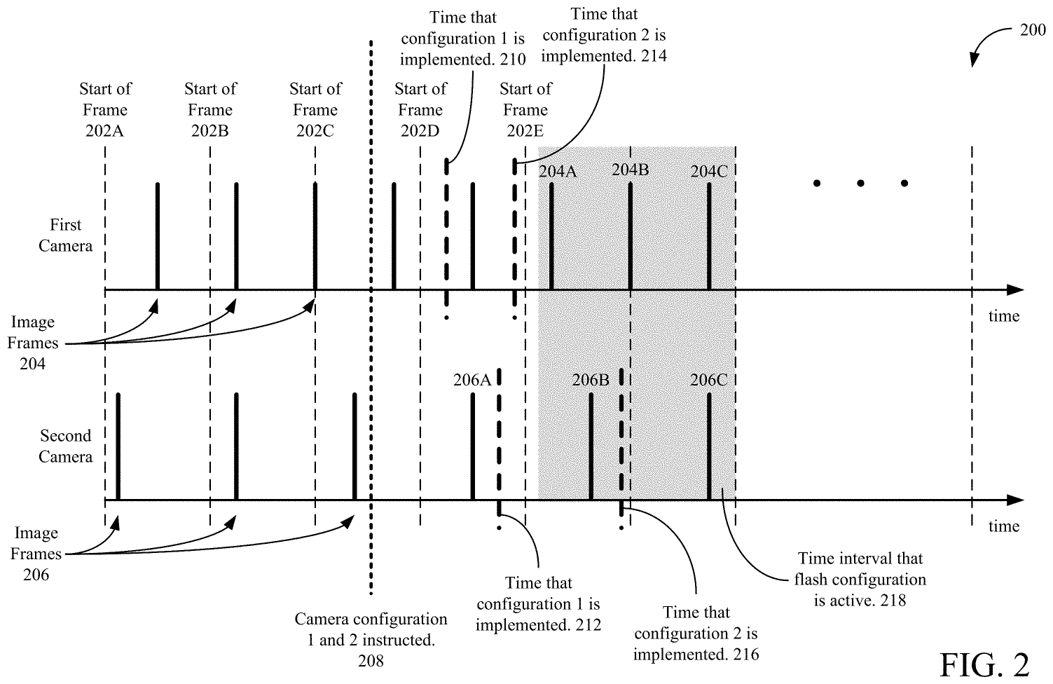

FIG. 2 is a depiction of an example image frame timeline 200 for a first camera and a second camera with the start of frame (202A 202E) as defined by the device (such as by an imaging application being executed). The first camera may provide a first stream of image frames 204, and the second camera may provide a second stream of image frames 206. As shown, the image frames 204 for the first camera may be captured at a higher rate (more frequent) than the image frames 206 for the second camera. In some examples, the lines for the image frames 204 and 206 may indicate when the processed image frame is available to the application processor. In some alternative examples, the lines for the image frames may indicate when the camera has complete sampling the image sensor, when the camera begins sampling the image sensor, when the image frame is provided from the camera to the image signal processor or camera controller for processing, or any other suitable place in the image processing pipeline for an image frame.

Both the first camera and the second camera may be instructed, at time 208, to adjust a first camera configuration (configuration 1) and a second camera configuration (configuration 2). For example, the cameras may be configured to adjust a focal length and an ISO setting. The cameras may execution the configuration instructions in sequence (such as first adjusting configuration 1, then adjusting configuration 2). Time 210 represents when configuration 1 is implemented by the first camera. Time 212 represents when configuration 1 is implemented by the second camera. Time 214 represents when configuration 2 is implemented by the first camera. Time 216 represents when configuration 2 is implemented by the second camera.

As shown, the frame rate for the first camera may be greater than the frame rate for the second camera. For example, the clock rate for the first camera may be higher than the clock rate for the second camera. Similarly, the first camera may implement the configuration changes quicker than the second camera. As a result, the second camera may capture one or more image frames with different configurations than the first camera during such changes. Shaded time interval 218 represents when a device flash is active, and image frames 204A 204C for the first camera and image frames 206B 206C for the second camera may be captured during the flash.

Associating an image frame 204A with an image frame 206A may be inappropriate for an imaging application as the camera configurations between the first camera and the second camera may be different and the device flash is active during the first camera image frame 204A while not active during the second camera image frame 206A.

Some device manufacturers may attempt to synchronize the hardware during the manufacturing process in order to make a real-time system for aligning image frames, such as where final processed image frames from multiple streams are provided at the same time for 3D imaging or other multiple camera applications. For example, the manufacturer may know the information of the different components and the device design that may affect temporal alignment of image frames. The manufacturer may then attempt to configure the hardware to align the exposure times for the image sensors or to align the end of frames for the image sensors. However, with manufacturing defects or other small imperfections in manufacturing that may cause minor differences between devices of the same type, the hardware synchronization for one device may not be sufficient for another device of the same type. Also, as the device ages, components may begin to operate differently (such as slower camera shutters or image sensor sampling), and the hardware synchronization during manufacture may no longer be sufficient. Other delays further into the image processing pipeline also may cause associated processed image frames to be output at different times.

Different imaging applications or programs may have different requirements for imaging. For example, real-time applications, such as AR, may have lower latency requirements than other imaging applications (such as generating stereoscopic images for later viewing). As a result, the temporal proximity requirement for receiving the associated processed image frames by an applications processor may be different depending on the 3D imaging application.

Further, the complexity of attempting to perform hardware synchronization may be so great, that the cost and time requirements may be unfeasible for the device manufacturer. For example, an example image processing pipeline from the cameras (such as the first camera 101 and the second camera 102 in FIG. 1) to the image signal processor (such as the image signal processor 112 in FIG. 1) may have so many variables to be accounted for during synchronization, attempting to align when the processed image frames are provided from the image signal processor to an applications processor (such as the processor 104 in FIG. 1) may be too difficult and costly.

Hardware synchronization may not be sufficient and/or may be cost prohibitive for a device manufacturer. Therefore, some device manufacturers skip attempting to perform hardware synchronization. Instead, device manufacturers may rely on a soft real-time system where the associated processed image frames are within a threshold amount of time from each other. The device manufacturer may only determine that the time between associated processed image frames being available from the image processing pipeline is within a universal tolerance amount of time. As a result, 3D images, stitched images, stacked images, or otherwise fused images may include defects or artifacts (such as ghosting or blurring).

In one example, if a VR headset displays processed image frames from a first camera to the left eye and displays associated processed image frames from a second camera to the right eye (such as using different displays or different portions of the same display), differences in timing between frames displayed to the left eye and right eye may cause an unsatisfactory VR experience for the user. In another example, if the image sensors are exposed at different times for associated image frames, a resulting stereoscopic image to be viewed later may have ghosting or other artifacts caused by scene changes between the exposure times.

In another example, if processed image frames are to be stacked to increase the depth of field for a final image and the cameras are being configured or adjusted during image capture, associated image frames may be captured using different camera configurations between the multiple cameras. For example, if the ISO setting is being adjusted, with an image frame captured from a first camera after the ISO setting adjustment and an associated image frame captured from a second camera before the ISO setting adjustment, the measured luminance of the associated image frames may be different and cause uneven brightness in a final processed image after stacking.

In some example implementations, a device may perform temporal alignment of image frames between multiple cameras. For example, the image signal processor 112 in FIG. 1 may perform temporal alignment before providing the processed image frames to the processor 104 in FIG. 1 for the imaging application. In another example, the processor 104 may perform temporal alignment of image frames from multiple image streams before using the processed image frames for the imaging application. Temporal frame alignment may include determining which frame from a second camera is to be associated with a frame from a first camera. For example, image frames from an auxiliary camera may be associated to image frames from a primary camera.

The types of image frame association include time of receipt based association and camera configuration based association. For time of receipt based association for an imaging application, the imaging application prioritizes reducing latency in associating frames over image quality of a final processed image. The imaging application may be time sensitive (such as a real-time application, including virtual reality and augmented reality applications), and the device may associate frames received by the device closest in time. In this manner, amount of time for associating and processing the image frames may be reduced over attempting to associate frames not received closest in time by the device. For camera configuration based association, the imaging application prioritizes image quality of a final processed image over reducing latency in providing the associated frames. The imaging application may not be as time sensitive (such as a 3D imaging application for producing images to be viewed at a later time), and the device may associate frames captured using similar configurations between the cameras (such as both without flash, same ISO, etc.). In this manner, the image quality of a final image (such as a 3D image) increases and the amount of time to provide the final image also increases as compared to time of receipt based association.

In some examples, the alignment may be based on the time between when the processed image frames from the multiple cameras are ready for use by an applications processor (time of receipt based). In some further examples, the alignment may be based on the device configuration or camera configurations during image capture (camera configuration based). For example, the device may attempt to associate image frames when the flash is off for both captures or after a change in the ISO setting for both cameras (as well as any other configurations that may affect sensor sampling, such as focal lengths, ambient lighting, etc.). For either time of receipt based association or camera configuration based association, the alignment of frames may be based on the amount of overlap of the exposure times for the image frames from the multiple cameras. The device also may base associating the image frames from the multiple cameras exclusively based on the overlap of exposure times for the image frames.

While the following description uses the example device 100 in FIG. 1 for describing aspects of the present disclosure, the example device 100 is used for illustrative purposes only, and any suitable device or system may be used to perform temporal alignment. Further, while primary and auxiliary cameras are used in describing aspects of the present disclosure, other camera configurations (such as non-master slave configurations, including multiple independent cameras) may be used. The present disclosure should not be limited to the following examples, as other device and camera configurations or systems are contemplated.

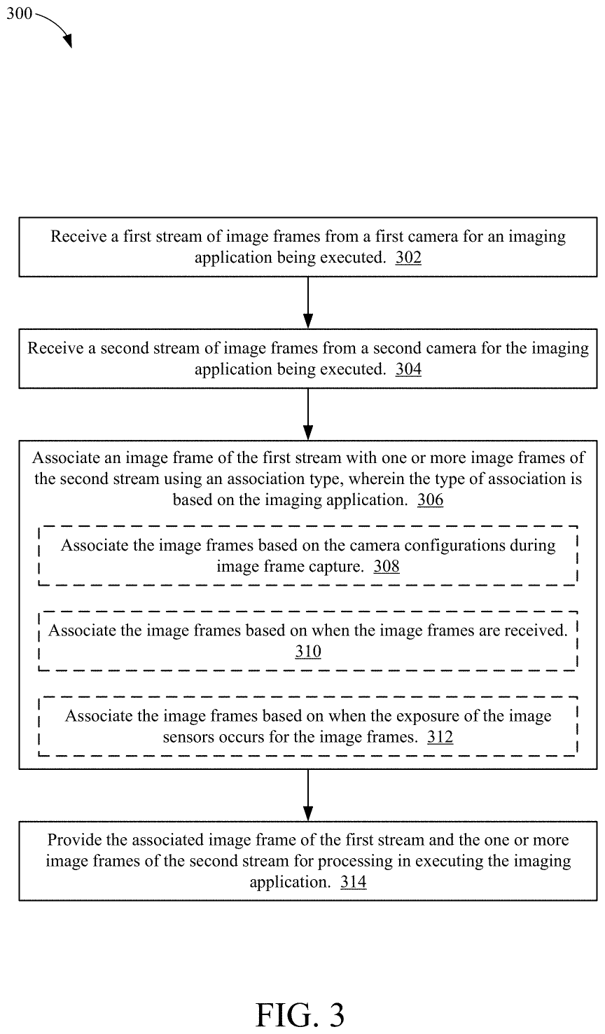

FIG. 3 is an illustrative flow chart depicting an example operation 300 for temporal alignment of image frames from multiple cameras. As described, temporal alignment of the image frames may include performing an association of image frames from a first image stream with image frames from a second image stream, even if the associated image frames from the multiple image streams are captured or received at different times.

The device 100 (FIG. 1) may receive a first stream of image frames from the first camera 101 for an imaging application being executed by the device 100 (302). In one example, the processor 104 may be an application processor executing an imaging application (such as for 3D imaging, image stacking, image stitching, or any other form of image fusion application). The camera controller 110 (such as the image signal processor 112) may receive the first stream of image frames.

The device 100 (such as the image signal processor 112) may also receive a second stream of image frames from the second camera 102 (304). With the two image streams, the device 100 (such as the image signal processor 112) may associate an image frame of the first stream with one or more image frames of the second stream using a type of association, wherein the type of association is based on the imaging application (306). In some example implementations, the association may be based on whether the imaging application is a 3D imaging application, a stitching application, a stacking application, or some other fusion application whose quality of imaging may be affected by the type of association.

In some examples of associating image frames, the image signal processor 112 may associate an image frame of the first stream with one or more image frames of the second stream based on the camera configurations for when the image frames are captured (308). Referring back to FIG. 2, image frame 204A from the first camera may not be associated with image frame 206A from the second camera because the flash is not on or off for both image frames. Further, image frame 204A may not be associated with image frame 206B from the second camera because configuration 2 has not yet been implemented by the second camera. As a result, the image frame 204A may be associated with an image frame 206C to attempt to keep the camera configurations consistent for the image frame captures. Camera configurations may also include whether the device configurations are changed during image frame capture.

Attempting to associate image frames based on the camera configurations may cause image frames with significant differences in time of capture or receipt by the image signal processor 112 to be associated. Stitching or stacking applications with a relatively static scene and device position may perform best using such a temporal alignment of image frames. For dynamic scenes (such as a lot of movement in the scene or action shots) or for VR or AR applications, latency in time of capture or time of receiving the image frames may be of more importance than the camera configurations for increased image quality.

In some other examples, the image signal processor 112 may associate an image frame of the first stream with one or more image frames of the second stream based on when the image frames are received from the cameras 101 and 102 (310 in FIG. 3). For example, a first image frame from the first camera 101 may be associated with the image frame received most recently from the second camera 102. Referring back to FIG. 2, image frame 204A may be associated with image frame 206A, and image frame 204B may be associated with image frame 206B. In some example implementations, if multiple image frames from the first camera are received before another image frame from the second camera is received, the multiple image frames from the first camera may be associated with the most recently received image frame from the second camera. For some VR or AR applications, the least amount of latency between associating image frames and processing the associated image frames may provide an improved user experience over associating image frames based on camera configurations (which may take longer).

In some other examples, the image signal processor 112 may associate an image frame of the first stream with one or more image frames from the second stream based on when the image sensors of the first camera and the second camera are exposed (312). For example, an image frame from the first stream may be associated with the image frame from the second stream whose exposure window most overlaps each other. Referring back to FIG. 2, if the exposure window for the image frame 204B is from the time at image frame 204A to before the time at image frame 204B, the image frame 204B may be associated with the image frame 206B or 206C (such as based on which image frame has a larger portion of overlapping exposure windows). Associating image frames based on exposure windows may attempt to reduce scene changes between associated image frames. For example, imaging applications for live action events (such as sporting events when the device moves or the scene changes) may provide a better user experience if the association of image frames is based on image sensor exposure instead of or in addition to when the images are received or based on camera configurations. In some example implementations, associating image frames based on when image frames are received (310) and associating image frames based on when the image sensors are exposed (312) may be the same process. Some examples of different association operations based on the imaging application are described in more detail below.

Referring back to FIG. 3, after associating the image frames, the device 100 may provide the associated image frame of the first stream and the one or more image frames of the second stream for processing in executing the imaging application (314). For example, the image signal processor 112 may provide the associated image frames to the processor 104 for the imaging application. The processor 104 may then process the image frames, such as stitching, stacking, 3D imaging, or other suitable image fusion based on the imaging application.

As shown in the example operation 300, different types of association operations or techniques may be performed, with the type of association operation to be used based on the requirements of the imaging application. If the device 100 is specific for an imaging application type (such as a headset for VR or AR), the device 100 may perform a specific type of association (such as associating image frames based on when the image frames are received). If the device 100 is able to execute different types of imaging applications (such as a smartphone that may be used for VR and stacking or stitching applications), the device 100 may be configured to determine which association operation or technique to be performed based on the imaging application being executed at the time.

For digital photography (such as using image stacking or stitching to increase the depth of field or the field of view), temporal alignment of image frames where associating image frames is based on similar camera configurations may be more suitable than associating image frames based on time received or captured. During the capture of the image streams, different camera configurations may be adjusted (such as the focal length, ISO setting, etc.). If the scene may change or the camera may move during capture (such as when recording sporting events or live action shots), the device 100 may adjust camera configurations as quickly as possible. In this manner, all image streams may be captured using the adjusted camera configurations as quickly as possible.

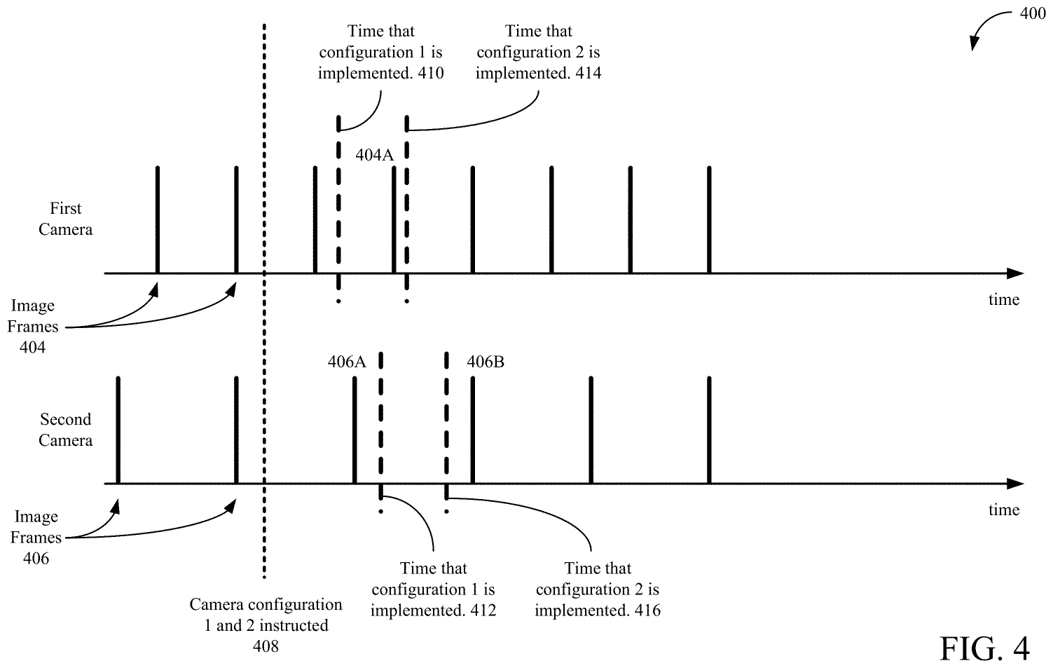

An example association operation based on camera configurations may include the cameras adjusting the configurations as soon as commands or instructions to adjust the configurations are received. FIG. 4 is a depiction of an example image frame timeline 400 for a first camera and a second camera for which camera configuration based image frame association is performed. If multiple camera configurations are to be adjusted for a camera, the camera may adjust the configurations in sequence. For example, a first camera may capture a first stream of image frames 404, and the second camera may capture a second stream of image frames 406. At time 408, both the first camera and the second camera may be instructed to adjust a configuration 1 and a configuration 2. The instructions may be provided by an image signal processor 112 or camera controller 110 for controlling the cameras 101 and 102.

The instructions may be sequentially received (such as first receiving the instruction to adjust configuration 1 and then receiving the instruction to adjust configuration 2), and a camera may perform the adjustments in the order the instructions are received. In the example timeline 400, the cameras adjust the configuration or otherwise execute the received instructions as soon as receiving the instructions at time 408. For example, the first camera may begin adjusting configuration 1 upon receiving the instruction at time 408, and complete the adjustment at time 410. The first camera may then begin adjusting configuration 2 upon completing the first adjustment, and complete the adjustment at time 414. Similarly, the second camera may begin adjusting configuration 1 upon receiving the instruction at time 408, and complete the adjustment at time 412. The second camera may then begin adjusting configuration 2 upon completing the first adjustment, and complete the adjustment at time 416. In the example implementation, the device 100 may not delay configuring the cameras, and the cameras may be adjusted as soon as possible. For example, configuration 1 and configuration 2 may be adjusted for the second camera before an image frame 406 is captured between adjusting configuration 1 and adjusting configuration 2.

In associating image frames based on camera configurations, the device 100 may associate the image frames with the closest captures. For example, if multiple image frames 406 of the second stream are captured using the same camera configurations as an image frame 404 of the first stream, the device 100 may associate the image frame 406 captured or received closest in time to the image frame 404 being captured or received, respectively. However, in adjusting the cameras as quickly as possible (without delaying the adjustments), some image frames from the first camera may not have a corresponding image frame from the second camera that was captured with similar camera configurations. For example, image frame 404A is captured after adjusting configuration 1 but before adjusting configuration 2. Image frame 406A is captured before adjusting configuration 1 or configuration 2, and image frame 406B is captured after adjusting configuration 1 and configuration 2.

The device 100 may associate image frame 404A with an image frame captured using the closest matching camera configurations. The device 100 may also consider the most recent captured image frame for the other camera stream. For example, image frame 404A may be associated with image frame 406A even though the camera configurations are not the same for the first camera and the second camera. In some example implementations, the device 100 associates an image frame from the first camera only with one or more preceding image frames from the second camera. In this manner, the latency in associating the image frames is reduced since the device 100 does not need to wait for additional image frames from the second camera.

A stitched, stacked, or otherwise fused image resulting from the associated image frames 404A and 406A may include artifacts or defects as a result of the different camera configurations. For moving scenes or cameras (such as live action shots or sporting events), the trade-off of quickly adjusting the cameras compared to a momentary disruption to the final images during the adjustments may be satisfactory. However, for static scenes and a static device position (such as landscape photography), the trade-off may not be satisfactory.

In some example implementations of ensuring that an image frame from a first camera may be associated with an image frame from a second camera, where both image frames are captured using the same or similar camera configurations, the device 100 may delay adjusting one or more of the configurations. For example, the device 100 may delay performing each adjustment until a threshold number of image frames are captured using the previous camera adjustment.

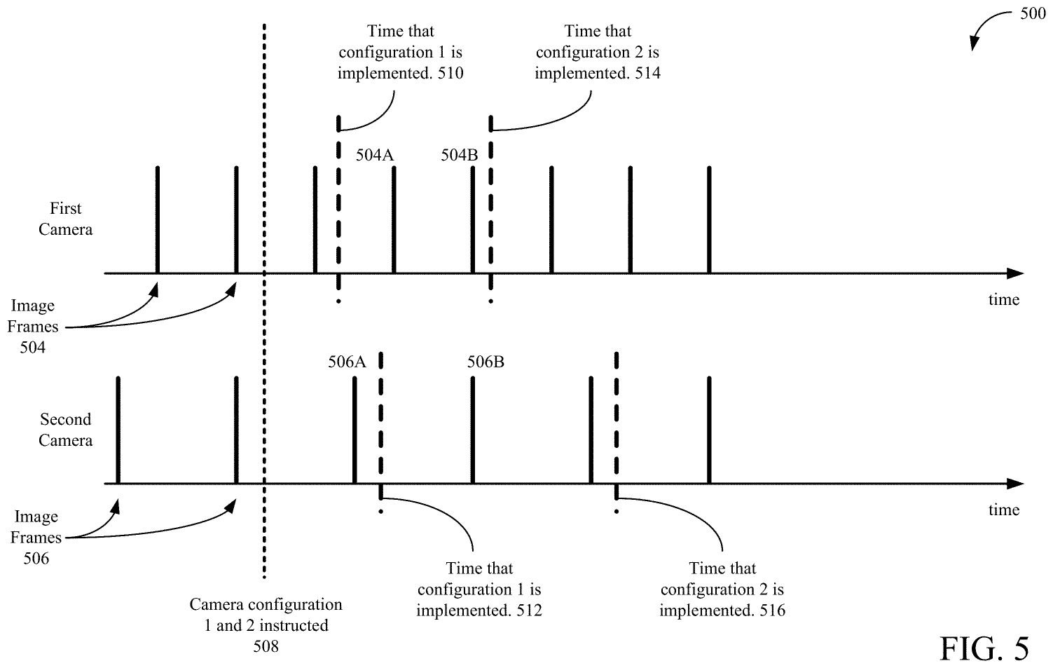

FIG. 5 is a depiction of another example image frame timeline 500 for a first camera and a second camera for which camera configuration based image frame association is performed. Both the first camera and the second camera may be instructed, at time 508, to adjust a first camera configuration (configuration 1) and a second camera configuration (configuration 2). The device 100 delays adjusting each camera configuration until at least a threshold number of two image frames are captured between adjusting a configuration. For example, two image frames 504 are captured between time 510 when configuration 1 is adjusted and time 514 when configuration 2 is adjusted. Similarly, two image frames 506 are captured between time 512 when configuration 1 is adjusted and time 516 when configuration 2 is adjusted. While the threshold number of image frames is illustrated as two, any threshold number (one or more) may be used, and the present disclosure should not be limited to a specific threshold.

In some example implementations, the device 100 delays execution of the instructions for adjusting configuration 2 until a threshold number of image frames are captured after adjusting configuration 1. For example, the image signal processor 112 may buffer the instructions for configuration 2. Once the threshold number of image frames for a first camera 101 is received, the image signal processor 112 may provide the instruction to the camera 101 to be executed. Alternatively, the image signal processor 112 may buffer camera specific commands until the threshold number of image frames are received for the camera. The image signal processor 112 may perform a similar operation for the second camera 102.

In some other example implementations, if the first camera 101 is a primary camera, the device 100 may configure the first camera 101 as soon as possible (without a delay). To ensure that each image frame may be associated with an image frame from the second camera 102, the device 100 may delay adjusting a camera configuration until a threshold number of image frames are captured by the second camera 102 using the previous configurations. In this manner, configuring the primary camera is not delayed while still ensuring image frames may be associated with image frames captured using the same camera configurations.

For example, image frame 504A may be associated with image frame 506B. Image frame 504B may also be associated with image frame 506B since the camera configurations are the same and image frame 506B is captured temporally closer to the capture of image frame 504B than any other image frame 506. Alternatively, if the device 100 is to associate an image frame from the first camera only with preceding image frames from the second camera, image frame 504A may be associated with 506A. However, for imaging applications (such as landscape photography) where latency is less of a concern than for other imaging applications, allowing association of image frames from before or after the image frame may be more suitable than requiring association with image frames preceding the image frame. For example, artifacts and defects may be reduced by not requiring association with preceding image frames, since the camera configurations may be more likely to be the same when capturing the associated image frames.

In addition or alternative to associating image frames based on camera configurations, the device 100 may associate image frames based on the overlap of exposure time for the image sensor. In this manner, the device 100 may attempt to ensure the scene is as close to the same as possible between the image frames from the multiple cameras. Such association may be beneficial for live event (such as sporting events) where the scene may change constantly.

While, in some example implementations, each image frame from the first camera 101 is associated with at least one image frame from the second camera 102, an image frame from the first camera 101 may remain unassociated with an image frame from the second camera 102. For example, referring back to FIG. 4, image frame 404A may remain unassociated with an image frame 406 since none of the image frames 406 are captured using the same camera configurations. In this manner, the image signal processor 112 may provide the image frame 404A to the processor 104 as unassociated. The processor 104 may then determine whether to use or discard the unpaired image frame for the imaging application.

In another example, an image frame of a first stream may remain unassociated if the exposure window for an image frame of the second stream does not overlap the exposure window for the image frame of a first stream by at least a threshold amount (such as 50 percent of time, 80 percent of time, a threshold amount of time, or another suitable measurement of the overlap of the exposure windows). In this manner, the unassociated image frame may be provided for the imaging application.

Additionally or alternatively, if an image frame from the second camera remains unassociated, the device 100 (such as the image signal processor 112) may discard the image frame. For example, if the second camera 102 is an auxiliary camera to the first camera 101, any unassociated image frames from the second camera 102 may be discarded by the image signal processor 112 and not provided to the processor 104. In this manner, the unassociated image frames from the primary camera (such as the first camera 101) may be provided for the imaging application (regardless if used by the imaging application) while the unassociated image frames from an auxiliary camera (such as the second camera 102) may be discarded and thus not provided for the imaging application.

Referring back to the association techniques, in contrast to association based on camera configurations and/or exposure window overlap, some imaging applications (such as real-time applications) may be more sensitive to latency and timing requirements between image frames than other imaging applications. For example, a VR application may display images of a scene in real-time at a constant rate, as compared to an imaging application that provides an image for later viewing. In this manner, reducing the time between receiving the image frames and associating the image frames may be more important than ensuring the camera configurations are the same for both cameras or the exposure window overlap is maximized for the image sensors during image frame association. In some example implementations, the device 100 may perform temporal alignment by associating image frames received closest in time. For example, an image signal processor 112 may associate an image frame from the first camera 101 with the image frame most recently received from the second camera 102.

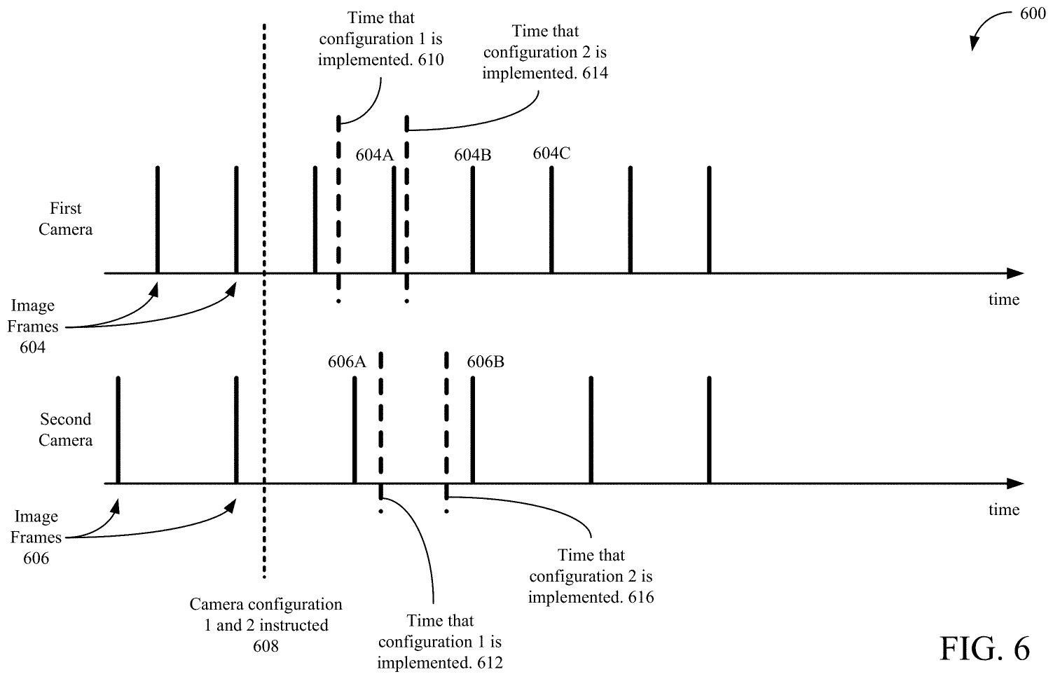

FIG. 6 is a depiction of an example image frame timeline 600 for a first camera and a second camera for which time of receipt based image frame association is performed. In one example, time of receipt based image frame association may include associating image frames based on when the image processor 112, or another component of the device 100 configured to perform the association, receives the image frames. In another example, the association may be based on when the image frames are to be received by the applications processor executing the imaging application (such as the processor 104 in FIG. 1).

Similar to the previous timelines (such as timelines 400 and 500 in FIGS. 4 and 5), the cameras may be instructed to adjust a configuration 1 and a configuration 2 (at time 608). Configuration 1 and configuration 2 may be adjusted for the first camera at time 610 and time 614, respectively. Configuration 1 and configuration 2 may be adjusted for the second camera at time 612 and time 616, respectively. In some example implementations of time of receipt based image frame association, the device 100 (such as the image signal processor 112) may associate an image frame from the first camera only with preceding image frames from the second camera (thus not waiting for another image frame to be received from the second camera). For example, image frame 604A may be associated with image frame 606A, image frame 604B may be associated with image frame 606B, and image frame 604C also may be associated with image frame 606B. The association may be irrespective of camera configurations.

In this manner, the first camera providing the image frames 604 may be a primary camera, and the second camera providing the image frames 606 may be an auxiliary camera. For some real-time imaging applications, refreshing the displayed or final images of the imaging application may be based on the frame rate of the primary camera. For example, the images for the imaging application may be refreshed for each image frame from the primary camera received, and the association may not delay providing the image frames from the primary camera to the applications processor for use.

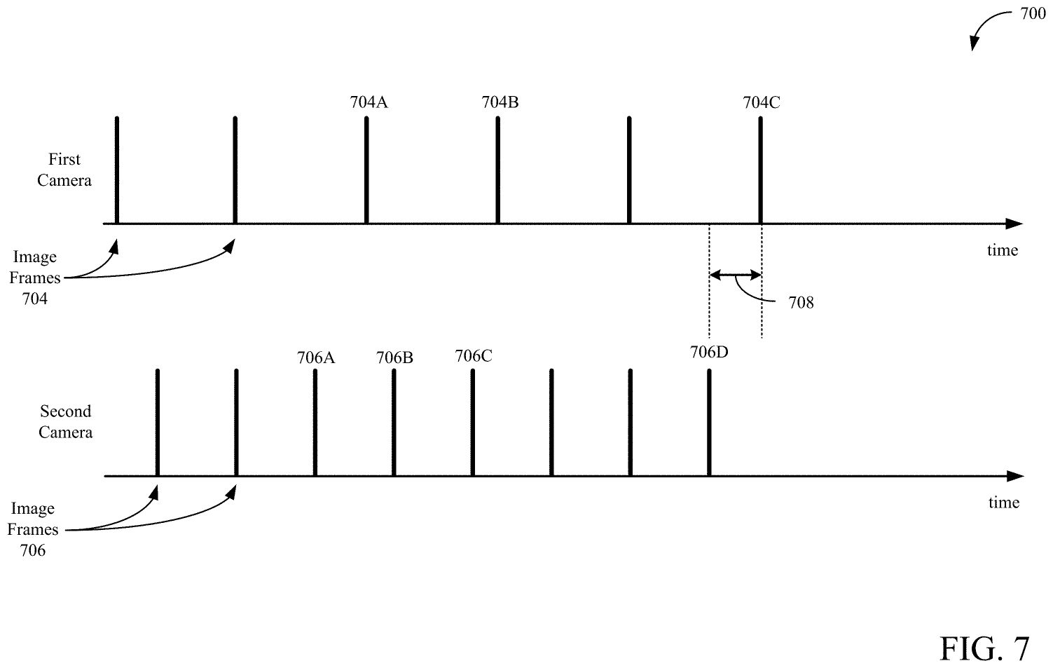

While the previous example illustrations of temporal alignment of image frames includes a first stream with a higher frame rate than a second stream, the frame rates may be the same or the first stream may have a lower the frame rate than the second stream. FIG. 7 is a depiction of an example image frame timeline 700 for a first camera and a second camera where the frame rate for the first camera (providing the image frames 704) is less than the frame rate for the second camera (providing the image frames 706).

For time of receipt based image frame association, image frame 704A may be associated with image frame 706A. Further, image frame 704B may be associated with image frame 706C. In some example implementations, image frame 704B may also be associated with 706B. If an image frame of the first stream is associated with multiple image frames of a second stream, all of the associated image frames may be provided to the application processor for use for the imaging application. For example, the associated image frames from the second stream may be stacked or otherwise fused, and the fused image and the associated image frame from the first stream may be used for the imaging application. Other example fusion processes include a simple averaging, a weighted averaging, stitching, etc.

For the association techniques, and as described above regarding camera condition based image frame association, an image frame from the first stream or the second stream may not be associated with an image frame from the other stream. For exposure based association, an image frame may not be associated with another image frame if the exposure windows for the image frames do not overlap by a threshold amount. For time of receipt based association, an image frame may not be associated with another image frame from the other stream if an image frame from the other stream is not received within a threshold amount of time previous to receiving the image frame. Referring back to FIG. 7, image frame 704C may not be associated with image frame 706D if, e.g., the time period 708 is greater than a threshold amount of time.

While the examples illustrate image frames being captured or received at a periodic interval, sometimes an image frame may not be received for an image stream. In one example, an image frame may not be captured when adjusting one or more configurations of the camera. In another example, an error may be experienced when sampling the image sensor. In some example implementations, the device 100 may determine if an image frame of the first stream impacted by a missing image frame of the second stream may be associated with one or more of the existing image frames of the second stream. If not, the image frame may remain unassociated. If the unassociated image frame is from a primary camera, the unassociated image frame may be provided to the applications processor. If the unassociated image frame is from an auxiliary camera, the unassociated image frame may be discarded instead of being provided to the applications processor.

In executing the imaging application, the applications processor may process the received associated image frames (and unassociated image frames) as instructed by the imaging application. For example, stacking applications may discard unassociated image frames, while for VR or AR imaging a device may use an unassociated image frame from a first stream with an older image frame from a second stream. Any suitable processing of the image frames may be performed after association for the imaging application.

While some image frame features for temporal alignment techniques have been described, temporal alignment may be based on other image frame features, such as the start of the frame capture, the center of the frame capture, the center of the exposure window, the capture duration, the exposure duration, etc. The present disclosure should not be limited to a specific image frame feature for temporal alignment, including association. Further, while association of image frames has been described, temporal alignment also may include adjusting the start of frame, start of capture, or other suitable features of an image stream for one or more of the cameras. In this manner, association of image frames may be in addition to adjusting the timing of image frames. In some example implementations, a success or failure rate of associating image frames may be used to determine to adjust the time of image frames. For example, if a threshold number of image frames from a primary camera remain unassociated, the device may adjust the timing of an auxiliary camera's image frames to attempt to increase the success of associating image frames from the primary camera.

Various thresholds have been described above. The thresholds may be predetermined or user determined. The thresholds may be based on operation of the device or may be adjustable by the user. Alternatively, one or more thresholds may be fixed throughout operation of the device. Any suitable threshold and method for adjusting or handling thresholds may be used, and the present disclosure should not be limited to a specific example for each threshold.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 106 in the example device 100 of FIG. 1) comprising instructions 108 that, when executed by the processor 104 (or the camera controller 110 or the image signal processor 112), cause the device 100 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 104 or the image signal processor 112 in the example device 100 of FIG. 1. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. For example, the steps of the described example operations, if performed by the device 100, the camera controller 110, the processor 104, and/or the image signal processor 112, may be performed in any order and at any frequency. Furthermore, although elements may be described or claimed in the singular, the plural is contemplated unless limitation to the singular is explicitly stated. For example, while two streams of image frames are described in the examples, any number of streams may be used. Accordingly, the disclosure is not limited to the illustrated examples and any means for performing the functionality described herein are included in aspects of the disclosure.

1. A method for a device to temporally align image frames from multiple cameras, comprising:
receiving a first stream of image frames including at least a first frame from a first camera for an imaging application being executed by the device;
receiving a second stream of image frames including at least a second frame from a second camera for the imaging application;
determining, based on the imaging application, whether to associate the first frame with the second frame using a type of association;
in response to determining to associate the first and the second frames, associating the first and the second frames using the type of association; and
providing the associated first and second frames for processing in executing the imaging application.

2. The method of claim 1, wherein the device determines to associate the first frame with the second frame based on one or more of:
the imaging application prioritizing image quality of a final processed image over reducing latency in providing the associated frames; and
the type of association being camera configuration based.

3. The method of claim 2, wherein the imaging application further prioritizes associating image frames captured using the same camera configurations for the first camera and the second camera over reducing the latency in adjusting the configurations of the first camera and the second camera, the method further comprising:
providing instructions to adjust an at least one configuration of the first camera and the second camera, wherein the second camera is configured to delay adjusting the at least one configuration until after capturing an at least one image frame of the second stream with the previous configuration.

4. The method of claim 3, wherein providing instructions includes providing for the second camera a first instruction to adjust a first configuration and a second instruction to adjust a second configuration, wherein the second camera is configured to:
adjust the first configuration;
delay adjusting the second configuration;
capture an image frame of the second image stream using the adjusted first configuration and the unadjusted second configuration; and
adjust the second configuration after capturing the image frame.

5. The method of claim 2, wherein the device determines to associate the first frame with the second frame further based on the imaging application prioritizing reducing the latency in adjusting the configurations of the first camera and the second camera over associating image frames captured using the same camera configurations for the first camera and the second camera, and the method further comprising:
providing instructions to adjust an at least one configuration of the first camera and the second camera, wherein the first camera and the second camera are configured to adjust the at least one configuration upon receiving the instructions.

6. The method of claim 1, wherein the device determines to associate the first frame with the second frame based on one or more of:
the imaging application prioritizing reducing latency in providing the associated frames over image quality of a final processed image; and
the type of association beings time of receipt based.

7. The method of claim 6, further comprising:
receiving a third stream of image frames including at least a third frame from the first camera for a second imaging application being executed by the device;
receiving a fourth stream of image frames including at least a fourth frame from the second camera for the second imaging application being executed by the device;
determining, based on the second imaging application, whether to associate the third frame with the fourth frame using a camera configuration type of association;
in response to determining to associate the third and the fourth frames, associating the third and the fourth frames using the camera configuration type of association, wherein the second imaging application prioritizes image quality of a final processed image for the second imaging application over reducing latency in providing the final processed image; and
providing the associated third and fourth frames for processing in executing the second imaging application.

8. The method of claim 1, further comprising:
in response to determining not to associate a third frame of the first stream with a fourth frame of the second stream, discarding the fourth frame.

9. A device configured to temporally align image frames from multiple cameras, comprising:
a memory; and
a processor coupled to the memory and configured to:
receive a first stream of image frames including at least a first frame from a first camera for an imaging application being executed by the device;
receive a second stream of image frames including at least a second frame from a second camera for the imaging application;
determine, based on the imaging application, whether to associate the first frame with the second frame using a type of association;
in response to determining to associate the first and the second frames, associate the first and the second frames using the type of association; and
provide the associated first and second frames for processing in executing the imaging application.

10. The device of claim 9, wherein determining to associate the first frame with the second frame is based on one or more of:
the imaging application prioritizing image quality of a final processed image over reducing latency in providing the associated frames; and
the type of association being camera configuration based.

11. The device of claim 10, further comprising the first camera and the second camera, wherein:
the imaging application further prioritizes associating image frames captured using the same camera configurations for the first camera and the second camera over reducing the latency in adjusting the configurations of the first camera and the second camera; and
the processor is further configured to provide instructions to adjust an at least one configuration of the first camera and the second camera, wherein the second camera is configured to delay adjusting the at least one configuration until after capturing an at least one image frame of the second stream with the previous configuration.

12. The device of claim 11, wherein the processor is further configured to provide for the second camera a first instruction to adjust a first configuration and a second instruction to adjust a second configuration, wherein the second camera is configured to:
adjust the first configuration;
delay adjusting the second configuration;
capture an image frame of the second image stream using the adjusted first configuration and the unadjusted second configuration; and
adjust the second configuration after capturing the image frame.

13. The device of claim 10, wherein determining, to associate the first frame with the second frame is further based on the imaging application prioritizing reducing the latency in adjusting the configurations of the first camera and the second camera over associating image frames captured using the same camera configurations for the first camera and the second camera, and the processor is further configured to:
provide instructions to adjust an at least one configuration of the first camera and the second camera, wherein the first camera and the second camera are configured to adjust the at least one configuration upon receiving the instructions.

14. The device of claim 9, wherein determining to associate the first frame with the second frame is based on one or more of:
the imaging application prioritizing reducing latency in providing the associated frames over image quality of a final processed image; and
the type of association being time of receipt based.

15. The device of claim 14, wherein the processor is further configured to:
receive a third stream of image frames including at least a third frame from the first camera for a second imaging application being executed by the device;
receive a fourth stream of image frames including at least a fourth frame from the second camera for the second imaging application being executed by the device;
determine, based on the second imaging application, whether to associate the third frame with the fourth frame using a camera configuration typo of association;
in response to determining to associate the third and the fourth frames, associate the third and the fourth frames using the camera configuration type of association, wherein the second imaging application prioritizes image quality of a final processed image for the second imaging application over reducing latency in providing the final processed image; and
provide the associated third and fourth frames for processing in executing the second imaging application.

16. The device of claim 9, wherein the processor is further configured to:
in response to determining not to associate a third frame of the first stream with a fourth frame of the second stream, discard the fourth frame.

17. A non-transitory computer-readable medium storing one or more programs containing instructions that, when executed by one or more processors of a device, cause the device to:
receive a first stream of image frames including at least a first frame from a first camera for an imaging application being executed by the device;
receive a second stream of image frames including at least a second frame from a second camera for the imaging application;
determine, based on the imaging application, whether to associate the first frame with the second frame using a type of association;
in response to determining to associate the first and the second frames, associate the first and the second frames using the type of association; and
provide the associated first and second frames for processing in executing the imaging application.

18. The non-transitory computer-readable medium of claim 17, wherein the device determines to associate the first frame with the second frame based on one or more of:
the imaging application prioritizing image quality of a final processed image over reducing latency in providing the associated frames; and
the type of association being camera configuration based.

19. The non-transitory computer-readable medium of claim 18, wherein:
the imaging application further prioritizes associating image frames captured using the same camera configurations for the first camera and the second camera over reducing the latency in adjusting the configurations of the first camera and the second camera; and
execution of the instructions further causes the device to provide instructions to adjust an at least one configuration of the first camera and the second camera, wherein the second camera is configured to delay adjusting the at least one configuration until after capturing an at least one image frame of the second stream with the previous configuration.

20. The non-transitory computer-readable medium of claim 19, wherein execution of the instructions further causes the device to provide for the second camera a first instruction to adjust a first configuration and a second instruction to adjust a second configuration, wherein the second camera is configured to:
adjust the first configuration;
delay adjusting the second configuration;
capture an image frame of the second image stream using the adjusted first configuration and the unadjusted second configuration; and
adjust the second configuration after capturing the image frame.

21. The non-transitory computer-readable medium of claim 18, wherein the device determines to associate the first frame with the second frame further based on the imaging application prioritizing reducing the latency in adjusting the configurations of the first camera and the second camera over associating image frames captured using the same camera configurations for the first camera and the second camera, and execution of the instructions further causes the device to:
provide instructions to adjust an at least one configuration of the first camera and the second camera, wherein the first camera and the second camera are configured to adjust the at least one configuration upon receiving the instructions.

22. The non-transitory computer-readable medium of claim 17, wherein the device determines to associate the first frame with the second frame based on one or more of:
the imaging application prioritizing reducing latency in providing the associated frames over image quality of a final processed image; and
the type of association being time of receipt based.

23. The non-transitory computer-readable medium of claim 22, wherein execution of the instructions further causes the device to:
receive a third stream of image frames including at least a third frame from the first camera for a second imaging application being executed by the device;
receive a fourth stream of image frames including at least a fourth frame from the second camera for the second imaging application being executed by the device;
determine, based on the second imaging application, whether to associate the third frame with the fourth frame using a camera configuration type of association;
in response to determining to associate the third and the fourth frames, associate the third and the fourth frames using the camera configuration type of association, wherein the second imaging application prioritizes image quality of a final processed image for the second imaging application over reducing latency in providing the final processed image; and
provide the associated frames for processing in executing the second imaging application.

24. A device configured to temporally align image frames from multiple cameras, comprising:
means for receiving a first stream of image frames including at least a first frame from a first camera for an imaging application being executed by the device;
means for receiving a second stream of image frames including at least a second frame from a second camera for the imaging application;
means for determining, based on the imaging application, whether to associate the first frame with the second frame using a type of association;
means for, in response to determining to associate the first and the second frames, associating the first and the second frames using the type of association; and
means for providing the associated first and second frames for processing in executing the imaging application.

25. The device of claim 24, wherein determining to associate the first frame with the second frame is based on one or more of:
the imaging application prioritizing image quality of a final processed image over reducing latency in providing the associated frames; and
the type of association being camera configuration based.

26. The device of claim 25, wherein the imaging application further prioritizes associating image frames captured using the same camera configurations for the first camera and the second camera over reducing the latency in adjusting the configurations of the first camera and the second camera, the device further comprising:
means for providing instructions to adjust an at least one configuration of the first camera and the second camera, wherein the second camera is configured to delay adjusting the at least one configuration until after capturing an at least one image frame of the second stream with the previous configuration.

27. The device of claim 26, further comprising means for providing for the second camera a first instruction to adjust a first configuration and a second instruction to adjust a second configuration, wherein the second camera is configured to:
adjust the first configuration;
delay adjusting the second configuration;
capture an image frame of the second image stream using the adjusted first configuration and the unadjusted second configuration; and
adjust the second configuration after capturing the image frame.

28. The device of claim 25, wherein determining to associate the first frame with the second frame is further based on the imaging application prioritizing reducing the latency in adjusting the configurations of the first camera and the second camera over associating image frames captured using the same camera configurations for the first camera and the second camera, and the device further comprising:
means for providing instructions to adjust an at least one configuration of the first camera and the second camera, wherein the first camera and the second camera are configured to adjust the at least one configuration upon receiving the instructions.

29. The device of claim 24, wherein determining to associate the first frame with the second frame is based on one or more of:
the imaging application prioritizing reducing latency in providing the associated frames over image quality of a final processed image; and
the type of association being time of receipt based.

30. The device of claim 29, further comprising:
means for receiving a third stream of image frames including at least a third frame from the first camera for a second imaging application being executed by the device;
means for receiving a fourth stream of image frames including at least a fourth frame from the second camera for the second imaging application being executed by the device;
means for determining, based on the second imaging application, whether to associate the third frame with the fourth frame using a camera configuration type of association;
means for, in response to determining to associate the third and the fourth frames, associating the third and the fourth frames using the camera configuration type of association, wherein the second imaging application prioritizes image quality of a final processed image for the second imaging application over reducing latency in providing the find processed image; and
means for providing the associated third and fourth frames for processing in executing the second imaging application.
